(19) United States
(12) Patent Application Publication
(10) Pub. No.: US 2010/0066911 A1
(43) Pub. Date: Mar. 18, 2010

(54) AMBIENT SYSTEM AND METHOD OF CONTROLLING THE AMBIENT SYSTEM

(75) Inventors: Mark Johannes Hendrikus Grotenhuis, Eindhoven (NL); Bram Kater, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/517,576

(22) PCT Filed: Dec. 5, 2007
(86) PCT No.: PCT/IB07/54927

§ 371 Date: Jun. 4, 2009

(30) Foreign Application Priority Data
Dec. 11, 2006 (EP) 06125785.3

(51) Int. Cl. H04N 5/58

(52) U.S. Cl. 348/602; 348/E05.12

(57) ABSTRACT

A method of controlling an ambient system (1) including a presentation apparatus (6-8, 16,17) for rendering a media signal and an ambience control system (2) for adjusting at least one perceptible aspect of ambient conditions prevailing in an environment of the presentation apparatus, includes selecting one of a set of media signals available for rendering based upon a mood to which the ambience control system has been set to adjust the at least one perceptible aspect of the ambient conditions. The method further includes obtaining respective measures of at least one characteristic of a plurality of the available media signals and making the selection using a mapping of the at least one characteristic to data representative of a mood space.

### FIELD OF THE INVENTION

The invention relates to a method of controlling at least one ambient device for adjust at least one perceptible aspect of ambient conditions.

The invention also relates to a control device for controlling at least one ambient device for adjust at least one perceptible aspect of ambient conditions, an ambient system including a presentation apparatus and the control device, and a computer program.

### BACKGROUND OF THE INVENTION

Mols, B., “For Sale: Mood Tuscany for your living room”, Delft Outlook 21 (1), 2004, pp. 3-7, describes an atmosphere control system that changes our environment. At the press of a button, a spoken command, or, in the most advanced configuration, by changing the shape of a work of art, the device will instantly change the look and feel of your living room. The system simultaneously changes the lighting, music, and even an image, still or moving, projected onto a wall. The device offers eight pre-programmed moods. Users can modify each of the basic moods to their own liking. A computer program simultaneously controls music, lighting and the art projected on the wall. In addition, the lights can still be switched on and off manually by the user. The system automatically stores the new settings. Ultimately, users should be able to load the atmosphere control with their own music collection and their own collection of art or photographs to create a personal digital mood file.

A problem of the known system is that it can only change the music and image projected on the wall to that combination previously associated with a particular mood. It requires a relatively extensive set-up, adapted to a particular person's collection of art, music and photographs and his categorisation thereof in terms of different moods.

### SUMMARY OF THE INVENTION

It is an object of the invention to provide a method, system and computer program of the types defined above that can be set up relatively easily to function on the basis of an arbitrary set of media signals available for rendering.

This object is achieved by the method of controlling at least one ambient device (4,5) for adjust at least one perceptible aspect of ambient conditions, the method comprising the steps of

obtaining, based on a desired value of the at least one perceptible aspect, target

settings for controlling the at least one ambient device (4,5), selecting one of a set of media signals available for rendering via a presentation apparatus (6-8, 16, 17), based upon data representative of the desired value, and

obtaining respective measures of at least one characteristic of the set of the media signals, for the selection of the media signal using data indicating a relationship between the at least one characteristic and the data representative of the desired value.

Instead of adapting the ambient conditions to the media signals, the present invention provides that the media signals are selected depending on a desired setting of one or more ambient conditions provided via ambient devices.

Because respective measures of at least one characteristic of a plurality of the available media signals are obtained and the selection is made using the relationship between the at least one characteristic and the data representative of the desired value, the method does not require annotation, either implicitly or explicitly, of the media signals to indicate to which mood they belong. The method can be set up on the basis of a set of available media signals that have not been categorised previously by a particular user.

An additional characteristic is that the method is independent of a particular user's conception of a mood, so that the ambient system may require little or no adjustment to different users. The mapping of the characteristics to the mood space is an embodiment of the data indicating the relationship.

In an embodiment, wherein the ambience control system includes at least one user control for providing respective input signals representative of a desired adjustment of at least one perceptible aspect of the ambient conditions, the method includes determining the mood on the basis of at least one of the respective input signals.

An effect is that it is relatively easy to determine the mood to which the ambience control system has been set to adjust the at least one perceptible aspect of the ambient conditions. The mood corresponds more closely to a deliberate adjustment.

A variant further includes adjusting at least one further perceptible aspect of the ambient conditions based upon the mood.

An effect is that repeated adjustments by the user of many different settings, each of which adjustments might cause a new determination of the mood, are avoided.

In an embodiment, wherein the media signals include at least a video component, the presentation apparatus includes a display device and the ambience control system includes at least an ambient lighting system. The method may include obtaining respective measures of at least one characteristic of a plurality of the available media signals that is visible when a media signal is rendered on the display device.

An effect is that a perceptible aspect of ambient conditions is matched to a type of media signal of which the experience is known to be strongly influenced by that perceptible aspect. Viewer fatigue is reduced and the realism of the video component is enhanced.

In a variant, the measure of at least one characteristic is representative of a dominant colour within at least a section of the video component of the media signal. The colour dominating a video sequence is a suitable perceptible aspect for matching to the ambient lighting conditions.

An embodiment of the method includes processing the selected one of the media signals to change at least one aspect, perceptible when rendered, of the media signal based upon the mood.

An effect is to help remove the limitations on the range of moods that can be evoked by the media signals in the set of media signals available for rendering.

In an embodiment, the selected one of the available media signals is obtained from a server system via a network link.

An effect is that a relatively large set of media signals, suitable for evoking one of a relatively large range of moods when rendered, is made available without requiring local storage. This is made possible due to the fact that the method is not reliant on a particular end user's annotation of media signals.

A variant includes sending a message carrying data for verification to a server system; and

receiving the selected one of the available media signals upon verification of the data by the server system.

An effect is that particular media signals can be made available only to particular users of the ambient system. This allows for a higher degree of adaptation to the person using the ambient system at a particular time.

According to another aspect, a control device is provided for controlling at least one ambient device for adjusting at least one perceptible aspect of ambient conditions, the control device being configured to

obtain, based on a desired value of the at least one perceptible aspect, target settings for controlling the at least one ambient device,

select one of a set of media signals available for rendering via a presentation apparatus, based upon data representative of the desired value, and

obtain respective measures of at least one characteristic of the set of the media signals, for the selection of the media signal using data indicating a relationship between the at least one characteristic and the data representative of the desired value.

The ambient system is provided, which comprises a presentation apparatus for rendering one or more media signals, and the control device. The control device may be connected to the presentation apparatus.

By obtaining respective measures of at least one characteristic of a plurality of the available media signals and select the media signal using e.g. a mapping of the at least one characteristic to data representative of a mood space, the control system is able to match a media signal selected for rendering to prevailing ambient conditions as perceived by a user of the presentation apparatus.

In an embodiment, the ambient system is configured to carry out a method according to the invention.

According to another aspect of the invention, there is provided a computer program including a set of instructions capable, when incorporated in a machine-readable medium, of causing a system having information processing capabilities to perform a method according to the invention or to constitute a system according to the invention.

### BRIEF DESCRIPTION OF THE DRAWINGS

The invention will be explained in further detail with reference to the accompanying drawings, in which:

FIG. 1 is a schematic diagram of an ambient system;

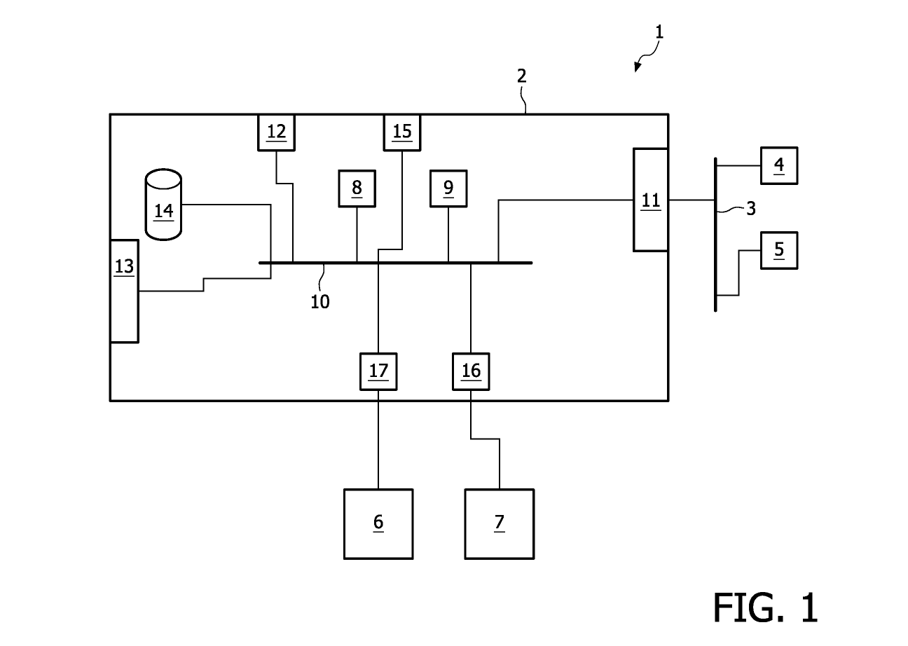

FIG. 2 is a flow chart of a first variant of a method of controlling an ambient system;

FIG. 3 is a schematic diagram of the ambient system in a network configuration; and

FIG. 4 is a flow chart of a second variant of a method of controlling an ambient system.

### DETAILED DESCRIPTION OF EMBODIMENTS

An ambient system 1 includes a main device 2, a home network bus 3 and devices 4-5 for changing ambient conditions, which devices 4-5 are connected to the home network bus 3. In addition, the ambient system 2 includes a display device 6 and a loudspeaker system 7. A controller 8 included in the main device 2 is operable to execute instructions stored in non-volatile memory 9, so as to control the operation of the ambient system 1 by means of data exchanged via a main device bus 10. The main device 2 further includes an interface 11 to the home network bus 3, enabling the controller 8 to control the devices 4-5 for adjusting at least one perceptible aspect of ambient conditions prevailing in an environment of the ambient system 1.

An exemplary first device 4 for adjusting at least one perceptible aspect of the ambient conditions comprises a lighting system. Suitable sources of ambient light include any number of known lighting devices, including LEDs, electroluminescent devices, incandescent lamps, ion discharge lamps, lasers, Liquid Crystal Display Devices and photoluminescent devices. The controller 8 is arranged to control at least one of the intensity, spectrum or spatial orientation of light emitted by the first device 4. An exemplary second device 5 for adjusting at least one perceptible aspect of the ambient conditions comprises a climate control system. The controller 8 is arranged to control the second device by setting a target temperature for a room in which the ambient system 1 is located. In other variants, other perceptible aspects of the ambient conditions prevailing in an environment of the ambient system 1 are adjusted by the controller 8 and appropriate devices in communication with the controller 8.

The main device 2 further includes user controls 12 for providing input signals representative of a function that the user wishes the ambient system 1 to fulfil. The user controls 12 include one or more elements suitable for physical manipulation by the user and transducers for converting the physical manipulations into the input signals. In an alternative variant to the one illustrated, the user controls 12 include an assembly of a remove control unit and a receiver in the main device 2 for receiving signals from the remote control unit.

The main device 2 also includes an interface 13 to a communications network, for example a Wide Area Network or a Local Area Network. In one variant, the interface 13 is an Ethernet interface. In another variant, the interface 13 is a wireless network interface.

The main device 2 also includes a storage device 14 for storing media signals. In the illustrated embodiment, the media signals are comprised in digital video files. In other variants, the media signals may be analogue video or audio signals on a tape or other storage medium. A device 15 for reading a data carrier allows video files to be loaded into the storage device 14. The device 15 may include any of an optical disk drive, a magnetic disk drive, an adapter for connecting a media device such as flash memory device, etc.

A video processor comprised in the controller 8 is configured to analyse any video signal comprised in a digital video file loaded via the device 15 for reading a data carrier or stored in the storage device 14. The video processor analyses the video signal by performing at least one algorithm for obtaining a measure of a characteristic of the video signal. Where several algorithms are performed, a feature vector may be generated, providing measures of several characteristics of the analysed video signal. In addition, or alternatively, an audio processor (not shown), may analyse the sound track accompanying the video signal to obtain a measure of a characteristic of the sound track.

The analysis, or analyses, may be carried out at any of several possible points in time. For example, the analysis may be carried out on a video file loaded from a data carrier via the device 15 for reading a data carrier, prior to storing the video file in the storage device 14. In such an embodiment, each video file will comprise (a link to) data representative of the measures of the characteristic of the audiovisual signal obtained through the analysis or analyses. Optionally, a mapping to a mood space is first applied to the feature vector, to obtain a quantitative representation of a point in a pre-defined mood space. In that case, this quantitative representation is stored with, or linked to, the video file. In one variant, the quantitative representation comprises a set of target settings for the first and second devices 4,5 for adjusting a perceptible aspect of the ambient conditions prevailing in an environment of the ambient system 1. In other embodiments, the analyses and mapping are also, or alternatively, carried out on some or all of the video files stored in the storage device 15 at a point in time determined by the controller 8, prior to making a selection of one of the video files available in the storage device 15 for rendering.

One way of obtaining a measure of a characteristic of the audiovisual signal comprised in a media file may involve computing a mood, or atmosphere, from a combination of low-lever, mid-level and high-level features of an input signal. In the case outlined here, the input signal comprises both video and audio information. Low-level features are extracted directly from the digital representation of the signal, such as the basic frequency, amplitude and characteristics of the signal in the time domain. Combining these low-level features yields mid-level features. These are not necessarily meaningful to a human user, as opposed to high-level features. High-level features are based on combinations of, and reasoning on low- and mid-level features and contextual information. They have a semantic meaning to a user. Any combinations of these features can be used as a selection criterion on which to base the selection of a video file.

Low-level features from a video signal may be the red, green and blue values of individual pixels that can be combined to a predominant colour in a specific region. In this manner, the predominant colour in a video sequence, or sub-sequence thereof—this may be a sub-sequence of one frame—is determined. Additionally or alternatively, it is possible to focus on a specific dimension of this colour, such as the red, blue or green channel, or to use a different representation of colours and focus on, for example, lightness, chroma (related to saturation) and hue dimensions. Examples of high-level indicators of mood include genre and the pace of shot changes.

For the audio component of an audiovisual signal, the dominant frequency, amplitude and frequency are low-level features that are used to extract mood information in one example, as well as changes in these dimensions over time. Standard signal processing techniques, such as the Fast Fourier Transform, are useful for calculating values for these dimensions from the input signal. Another characteristic of a sound track that could define the mood conveyed by it, is its mode, being major or minor.

In each of the above examples, an analysis of the, not yet rendered, media signal yields a measure of a characteristic of the media signal that is perceptible when the media signal is rendered.

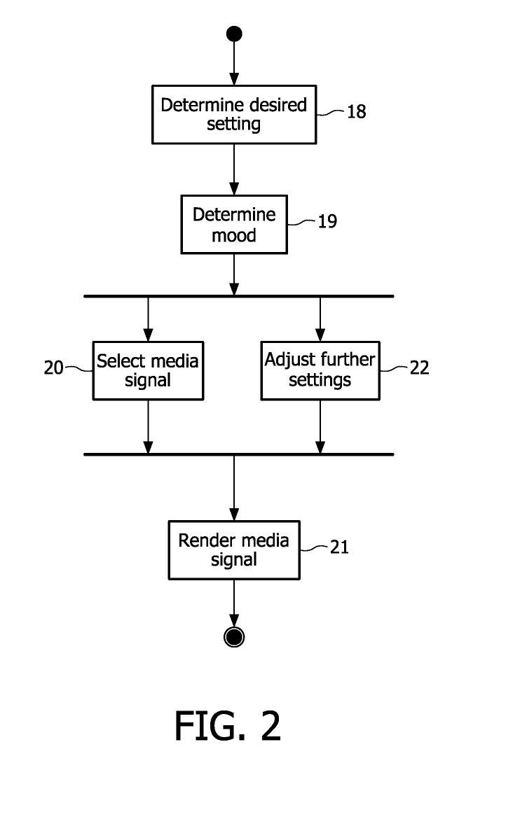

To render the audiovisual signal contained in a selected one of the video files, the ambient system 1 includes a presentation apparatus, comprising the controller 8, an audio output stage 16, a video output stage 17, the loudspeaker system 7 and the display device 6. The controller 8 selects a video file for rendering using a method illustrated in FIG. 2.

In one variant, the steps illustrated in FIG. 2 are executed each time it is determined that the ambient system 1 has been set to make a significant adjustment—more than a certain threshold value—to at least one perceptible aspect of the ambient conditions. In another variant, the steps are performed at certain time intervals.

In a first step 18, target settings for the devices 4,5 for adjusting at least one perceptible aspect of the ambient conditions are determined. It is possible to use sensors for detecting a change in the perceptible aspect of the ambient conditions, in which case the actual settings are assumed to conform to the target settings. For example, it is possible to commence the method upon detecting a change in the environment, and to measure the ambient conditions some time after the change has been detected. In the illustrated embodiment, input signals provided by the user controls 12 and representative of a desired adjustment of at least one perceptible aspect of the ambient conditions are used to determine the target settings.

In a second step 19, the mood is determined on the basis of at least one of the input signals. For example, the mood can be determined on the basis of certain target settings for the first device 4, e.g. the spectrum of light to be emitted.

Having determined the mood corresponding to the target settings for the first device 4, a video file is selected for rendering (step 20). This step 20 includes determining which of the feature vectors associated with the respective video files most closely matches the mood determined in the preceding step 19 according to an appropriate distance metric. In the illustrated embodiment, the video file is then automatically selected for rendering (step 21).

Concurrently, target settings of the second device 5 are adjusted (step 22), so as to adjust at least one further perceptible aspect of the ambient conditions, based upon the mood determined in the preceding step 19. To this end, one or more scripts may be stored in the main device 2 in a known format. Of course, where the mood is determined on the basis of only one perceptible aspect of the ambient light, other aspects of the ambient light may be similarly adjusted in this step 21 to match the mood.

In one variant, the video and/or audio component of audiovisual signal comprised in the selected video file is processed to change at least one visible or audible aspect thereof in dependence on the mood determined in the second step 19. For example, a particular colour component may be enhanced relative to the version of the video component of the audiovisual signal originally made available for rendering. Alternatively, or additionally, the volume at which the audio component is rendered may be adjusted in dependence on the mood.

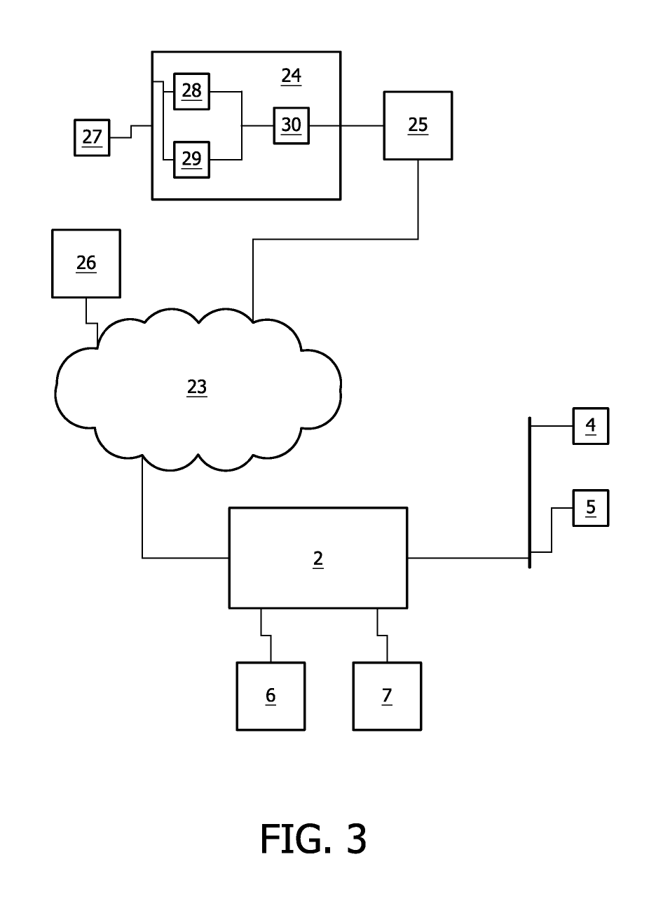

It will be appreciated that the ambient system 1 can be used in the manner explained above in a stand-alone configuration. In the stand-alone configuration, the interface 13 to a communication network need not be present. A set of video files can be made available for rendering by loading them to the storage device 14 via the device 15 for reading a data carrier. In a networked configuration (FIG. 3), the ambient system 1 is connected to a communications network 23. In one variant, the communications network 23 is a Local Area Network covering, for example, a hotel or similar building in which each room is provided with its own ambient system 1.

A server system comprises an analysis system 24, a storage system 25 and an authentication system 26. In the illustrated embodiment, the authentication system 26 and storage system 25 are provided with separate respective network adaptors, and are not physically co-located. In a variant, the server system is comprised in one single computer system with a network connection. Video files are read into the server system using a second device 27 for reading a data carrier. The analysis system 24 includes a video signal processor 28 and an audio signal processor 29. The video signal processor 28 is configured to analyse the video component of an audiovisual signal in a video file by performing at least one algorithm for obtaining a measure of a characteristic of the video component. Several algorithms may be performed to generate measures of several characteristics of the analysed video signal. The audio signal processor 29 analyses the sound track accompanying the video signal to obtain a measure of a characteristic of the sound track. A controller 30 associates data representative of the measures obtained by the video signal processor 28 and audio signal processor 29 with the video file. The video file and associated data are then transferred to the storage system 25.

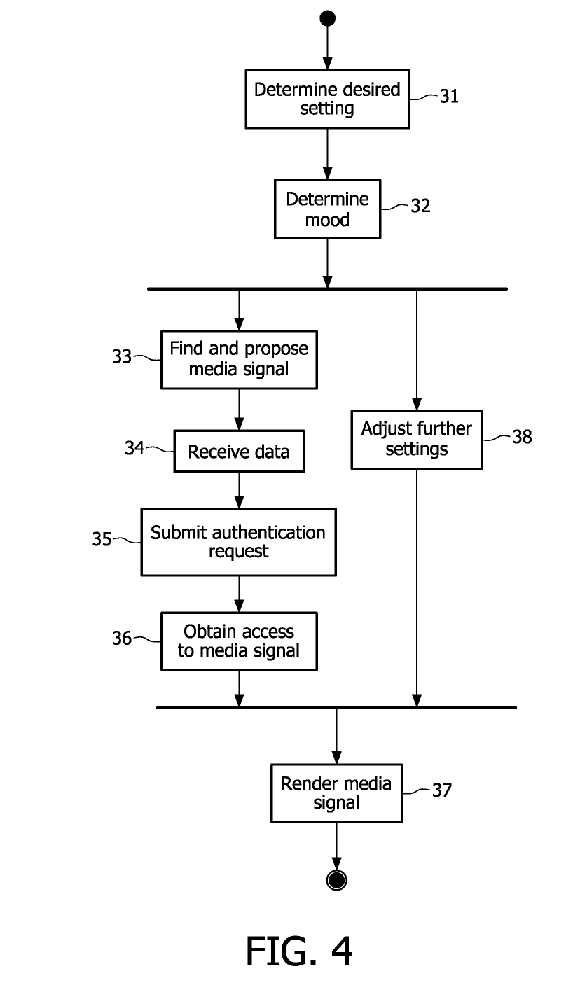

To select one of the video files available from the storage system 25, a method illustrated in FIG. 4 is carried out by the controller 8 comprised in the main device 2. Depending on the variant, the trigger to carry out the method is one of those described above in conjunction with FIG. 2.

In a first step 31, target settings for at least one of the devices 4,5 for adjusting at least one perceptible aspect of the ambient conditions are determined. This step 31 corresponds to the first step 18 of the variant illustrated in FIG. 2. A second step 32 corresponds to the second step 19 of the method of FIG. 2. In this step 32, the mood to which the ambient system 1 has been set to adjust the at least one perceptible aspect of the ambient conditions is determined.

Subsequently, a video file matching the mood is identified and proposed for selection to the user (step 33). In one variant, this step 33 involves transmitting a vector identifying a point in a pre-determined mood space to the storage system 25, whereupon the storage system 25 uses a mapping of the feature vectors characterising the video files to determine which most closely matches the mood determined in the preceding step 32. In another variant, data representative of the feature vectors is made available to the ambient system 1 with identifications of the respective associated video files, so that the controller 8 may perform the matching. The ambient system 1 may display an identification of the video file matching the mood on the display device 6. In a variant, a set of identifications of video files most closely matching the mood may be displayed.

In a subsequent step 34, the user is asked to confirm a selection. Optionally, the user is asked to input some authentication code, e.g. a PIN (Personal Identification Number) code or a credit card number. Data is then sent (step 35) in a message to the authentication system 26. Upon verification of the data in the message by the authentication system 26, the selected video file is made available (step 36) for rendering (step 37). The step 36 of making the selected video file available for rendering comprises, in one variant, the transmission of a message from the authentication system 26 to the storage system 25, authorising the download of the video file to the ambient system 1. In another variant, the authentication system 26 returns a message carrying authorisation data to the ambient system 1, and the ambient system send the authorisation data to the storage system 25. Other variants will occur to the skilled person.

The step 37 of rendering the audiovisual signal contained in the video file may, like the corresponding step 21 in the variant of FIG. 2, include the step of processing the selected one of the audiovisual signals to change at least one aspect, perceptible when rendered, of the signal, based upon the mood.

Like the method illustrated in FIG. 2, the method of FIG. 4 includes a step 38 of adjusting further perceptible aspects of the ambient conditions, based upon the mood determined in the preceding step 32. The adjustment of further perceptible aspects of the ambient conditions is carried out as described above in conjunction with the corresponding step 22 in the method of FIG. 2.

Thus, instead of determining ambient settings on the basis of a selected video file, the user is given the possibility of adjusting at least one aspect of the ambient settings. From this adjustment, the other ambient settings and the video file to be rendered follow automatically. Visible and/or audible characteristics of the video file are determined automatically and used to select the video file or files most closely resembling the mood that corresponds to the adjusted aspect of the ambient settings.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

For example, the home network bus 3 may be replaced by direct connections between e.g. light sources and drivers for those light sources in the main device 2. The authentication system 26 may be comprised in a portable device in communication with the main device 2 via an appropriate interface. It may, for example, be comprised in a chip card inserted in a card reader. Thus, the method illustrated in FIG. 4 can also be carried out in an ambient system in a stand-alone configuration.

1. Method of controlling at least one ambient device (4,5) for adjusting at least one perceptible aspect of ambient conditions, the method comprising the steps of
obtaining, based on a desired value of the at least one perceptible aspect, target settings for controlling the at least one ambient device (4,5),
selecting one of a set of media signals available for rendering via a presentation apparatus (6-8, 16, 17), based upon data representative of the desired value, and
obtaining respective measures of at least one characteristic of the set of the media signals, for the selection of the media signal using data indicating a relationship between the at least one characteristic and the data representative of the desired value.

2. The method of claim 1, further comprising steps of
obtaining the desired value of the at least one perceptible aspect based upon mood data representative of a user's mood, and
wherein the data indicating the relationship comprise are representative of a mapping of the at least one characteristic to data representative of a mood space.

3. Method according to claim 1, wherein the step of obtaining comprises a step of receiving, from at least one user control (12), respective input signals representative of the desired adjustment of the at least one perceptible aspect of the ambient conditions.

4. Method according to claim 1, further comprising a step of adjusting the at least one perceptible aspect based upon the desired value prior to the selection of media signal.

5. Method according to claim 1, wherein the media
signals include at least a video component, the presentation apparatus includes a display device (6) and the at least one ambient device (4,5) are comprised in an ambient lighting system (4).

6. Method according to claim 5, wherein the measure of at least one characteristic is representative of a dominant colour within at least a section of the video component of the media signal.

7. Method according to claim 1, including processing the selected one of the media signals to modify at least one aspect, perceptible when rendered, of the media signal based upon the desired value.

8. Method according to claim 1, wherein the selected one of the available media signals is obtained from a server system (25) via a network link.

9. Method according to claim 1, including sending a message carrying data for verification to a server system (26); and
receiving the selected one of the available media signals upon verification of the data by the server system (26).

10. A control device (2) for controlling at least one ambient device (4,5) for adjusting at least one perceptible aspect of ambient conditions, the control device being configured to
obtain, based on a desired value of the at least one perceptible aspect, target settings for controlling the at least one ambient device (4,5),
select one of a set of media signals available for rendering via a presentation apparatus (6-8, 16, 17), based upon data representative of the desired value, and
obtain respective measures of at least one characteristic of the set of the media signals, for the selection of the media signal using data indicating a relationship between the at least one characteristic and the data representative of the desired value.

11. Ambient system comprising
a presentation apparatus (6-8,16,17) for rendering one or more media signals, and the control device (2) of claim 10.

12. The ambient system of claim 11,
wherein the control system is configured to
obtain the desired value of the at least one perceptible aspect based upon mood data representative of a user's mood, and
select the media signal using a mapping of the at least one characteristic to data representative of a mood space.

13. Ambient system according to claim 11, configured to carry out a method of controlling at least one ambient device (4,5) for adjusting at least one perceptible aspect of ambient conditions, the method comprising the steps of
obtaining, based on a desired value of the at least one perceptible aspect, target settings for controlling the at least one ambient device (4,5),
selecting one of a set of media signals available for rendering via a presentation apparatus 16-8, 16, 17), based upon data representative of the desired value, and
obtaining respective measures of at least one characteristic of the set of the media signals, for the selection of the media signal using data indicating a relationship between the at least one characteristic and the data representative of the desired value.

14. Computer program including a set of instructions capable, when incorporated in a machine readable medium, of causing a system having information processing capabilities to perform a method according to claim 1.
